(19) United States
(12) Patent Application Publication
(10) Pub. No.: US 2004/0172375 A1
(43) Pub. Date: Sep. 2, 2004

(54) Method for determining the permitted working range of a neural network

(75) Inventors: Georg Mogk, Kurten (DE); Thomas Mrziglod, Bergisch Gladbach (DE); Peter Hubl, Leverkusen (DE)

Correspondence Address: CHRISTINA HILDEBRAND, NORRIS, MCLAUGHLIN & MARCUS, 220 EAST 42ND STREET - 30TH FLOOR, NEW YORK, NY, 10017, US

(73) Assignee: Bayer Aktiengesellschaft, Leverkusen (DE)

(21) Appl. No.: 10/758,322

(22) Filed: Jan. 15, 2004

(30) Foreign Application Priority Data
Jan. 16, 2003 (DE) 10301420.9

(51) Int. Cl. G06F 15/18; G06G 7/00; G06E 3/00; G06E 1/00

(52) U.S. Cl. 706/20

(57) ABSTRACT

A method for checking whether an input data record is in the permitted working range of a neural networkin which a definition of the complex envelope which is formed by the training input records of the neural network, and of its surroundings as the permitted working range of a neural network and checking whether the input data record is in the convex envelope.

### BACKGROUND OF THE INVENTION

1. Field of the Invention

The invention relates to a method for checking whether an input data record is in the permitted working range of a neural network, and to a corresponding computer program product and system.

2. Description of the Related Art

A plurality of application possibilities for neural networks are known from the prior art. Neural networks are used for data-driven model formation, for example for physical, biological, chemical and technical processes and systems, cf. Babel W.: “Einsatzmöglichkeiten neuronaler Netze in der Industrie: Mustererkennung anhand überwachter Lernverfahren—mit Beispielen aus der Verkehrs- und Medizintechnik”[translation of title: “Possibilities of use of neural networks in industry: pattern recognition using monitored learning methods—with examples from transportation and medicine technology”], Expert Verlag, Renningen-Malmsheim, 1997. In particular, the fields of use of neural networks include process optimization, image processing, pattern recognition, robot control and medicine technology.

Before a neural network can be used for predictive or optimization purposes, it must be trained. This usually involves adapting the weights of the neurons by means of an iterative method using training data, cf. Bärmann F.: “Prozessmodellierung: Modellierung von Kontianlagen mit neuronalen Netzen” [translation of title: “Process modelling: modelling of continuous systems with neural networks”], Internet page NN-Tool, www.baermann.de and Bärmann F.: “Neuronale Netze”. Skriptum zur Vorlesung, FH-Gelsenkirchen, Fachbereich Physikalische Technik, Fachgebiet Neuroinformatik [translation of title: “Neural networks”. Lecture paper. Technical University of Gelsenkirchen, Department of Physico-Technology, Subject area of neurocomputing], 1998.

The so-called back propagation method is particularly suitable for training a neural network. A further approach is implemented in the program “NN-Tool 2000”. This program is commercially available from Professor Frank Bärmann, Technical University of Gelsenkirchen, Department of Physical Technology. The corresponding training method is also described in the publication “Neural Network”, Volume 5, pages 139 to 144, 1992, “On a class of efficient learning algorithms for neural networks”, Frank Bärmann, Friedrich Biegler-König.

DE 195 31 967 discloses a method for training a neural network with the non-deterministic behaviour of a technical system. The neural network is integrated here into a control loop in such a way that the neural network outputs, as output variable, a manipulated variable to the technical system, and the technical system generates a controlled variable from the manipulated variable supplied by the neural network and said controlled variable is fed to the neural network as an input variable. Noise with a known noise distribution is superimposed on the manipulated variable before it is fed to the technical system. Further methods for training neural networks are known from DE 692 28 412 T2 and DE 198 38 654 C1.

In addition, a method for estimating the confidence level of the prediction which is output by a neural network is known from the prior art: Protzel P., Kindermann L., Tagscherer M., Lewandowski A. “Abschätzung der Vertrauenswürdigkeit von Neuronalen Netzprognosen bei der Prozessoptimierung [translated title: “Estimating the confidence level of neural network predictions when optimizing processes”], VDI Berichte [Reports] No. 1526, 2000. EP 0 762 245 B1 also discloses a method for recognizing faulty predictions in a neural-model-supported or neural process control system.

A common disadvantage of these methods known from the prior art is that they can only permit conclusions to be drawn about the sensitivity, in terms of variations of the training data, of the model which is made available by the neural network. However, it is thus not possible to draw conclusions about the confidence level of a prediction which is made by the neural network.

F. Bärmann; Handbuch zu NN-Tool 98 [translated title: “Neural Network Tool Manual”], 1998, discloses an approach in which it is attempted to estimate the prediction error at a specific point using the known prediction error at adjacent data points.

All these methods have in common the fact that it is not possible to draw a conclusion as to whether an input data record is at all in the permitted working range of the neural network. However, an incorrect estimation is possible only in this case.

The invention is therefore based on the object of providing a method which makes it possible to check whether an input data record is in the permitted working range of a neural network. In addition, the invention is based on the object of providing a corresponding computer program product.

The object on which the invention is based is achieved in each case with the features of the independent patent claims. Preferred embodiments of the invention are given in the dependent patent claims.

### SUMMARY OF THE INVENTION

The present invention makes it possible to check an input data record for a neural network to determine whether it is in the permitted working range of the neural network. The invention is based on the realization that structural information is not input into neural networks but instead only training input data records are used which have been, for example, obtained by measuring means. Due to this recognition, such models can provide trustworthy predictions only in the areas in which the models have been trained.

Between the given training data points it is possible to interpolate very efficiently using such models. However, in contrast to corresponding rigorous models, data-driven models cannot extrapolate, or can extrapolate only to a very restricted degree. Therefore, in particular for monitoring and/or controlling critical applications, it is advantageous that it is possible to check whether the model used is utilized in the permitted working range.

This applies to a greater degree also to hybrid models in which a plurality of neural networks is connected to rigorous models. Although hybrid models are capable of extrapolation as an overall model, the interpolation area must be checked for each individual data-driven subcomponent, that is to say, for the neural networks which are contained in the hybrid model.

According to the invention, the working range of a neural network is defined by the convex envelope formed by the training input data records of the neural network. For example, a neural network has a number of a inputs and a number of b outputs. To form models, data records for the a input parameters and the b output parameters are acquired by measuring means.

If, for example, a model is to be formed for a manufacturing process, the input parameters can be data relating to the materials used, their composition and/or parameters of the production system, for example pressures, temperatures and the like. The resulting product properties, for example, are then measured for the output parameters. In this way, training data records which each contain a set of input parameters and associated output parameters are obtained. The neural network is trained using these training data records, that is to say the weightings of the neurons are adapted iteratively.

According to one preferred embodiment of the invention, the following definition of the convex envelope is applied as a way of defining the permitted working range:

P is assumed to be a given, finite set of n points p₁, . . . ,pₙ. The points pᵢ (for i=1, . . . ,n) of the set P are formed by means of the training input data records with which the neural network has been trained. A point x, that is to say a specific input data record, is associated with the convex envelope which is formed by P and is referred to as conv(P) if it yields real numbers λ₁, . . . ,λₙ≧0 where λ₁+ . . . +λₙ=1 so that λ₁p₁+ . . . +λₙpₙ=x for pᵢεP (for i=1, . . . ,n). (On the theory of convex envelopes, see also: Dieter Jungnickel: “Optimierungsmethoden” [translated title: “Optimization methods”]; Springer, Heidelberg; 1999; ISBN: 3540660577).

According to one preferred embodiment of the invention, the direct surroundings of the convex envelope are also considered as a permitted working range as neural networks can also supply appropriate results in the direct vicinity of the convex envelope. However, the working range is alternatively restricted directly to the convex envelope as it is not possible to draw a precise conclusion as to where the “direct vicinity” ends. In particular for critical applications which relate, for example, to continuous production, the working range is therefore restricted to the interior of the convex envelope, the external surroundings in the direct vicinity of the convex envelope being excluded from the working range.

In the practical application, in particular in time-critical applications, it is of particular significance to use efficient procedures in order to determine whether an input data record is in the permitted working range of the associated neural network.

The algorithms Quickhull (see C. B. Barber, D. P. Dobkin and H. T. Huhdanpaa: “The Quickhull Algorithm for Convex Hulls”; ACM Transaction Mathematical Software; Vol. 22, No. 4; 1996; p 469-483, Simplex Algorithm) as well as the simplex algorithm (see, for example, Dieter Jungnickel: “Optimierungsmethoden” [translated title: “Optimization methods”]; Springer, Heidelberg; 1999; ISBN: 3540660577) are known per se from the literature. These methods are inefficient in highly dimensional spaces (i.e. input dimensions greater than 9) because they require extremely long computing times and fail on commercially available computers due to the memory requirement. On the other hand, in preferred embodiments of the invention it is possible to have recourse to three basically different, very efficient methods.

According to one preferred embodiment of the invention, firstly a simplex composed of a number of d+1 non-collinear points from the set P is formed in order to check whether an input data record is in the convex envelope, d being the dimension of the space formed by P. A point is then selected from the interior of this simplex. To do this, it is possible to use, for example, the center of gravity of the simplex which is calculated from the vertices of the simplex. This point is referred to below by x₀.

In the next step, the path [x, x₀] between the point x defined by the input data record and the point x₀ selected from the simplex is considered. It is then checked whether there is an intersection point of the path [x, x₀] with a facet of the simplex. The facets are the “side faces” of the simplex.

If there is no such intersection point, this means that the point x is in the interior of the convex envelope.

If the opposite is the case, this results in the point x being outside the simplex. However, this does not yet answer the question as to whether the point x is inside or outside the convex envelope. It is therefore checked whether it is possible to form a further simplex from d+1 non-collinear points from the set P in such a way that the further simplex contains the intersection point with the facet and a section of the path [x, x₀].

If this is not possible, the result of this is that the point x is outside the convex envelope (Caratheodory's set). If such a simplex can be formed, the check is carried out again to determine whether an intersection point of the path [x, x₀] exists with a facet of the further simplex. As there is only a finite number of points in P after a finite number of iterations, this method indicates whether or not x is in the convex envelope as all the simplices can be checked successively.

According to one preferred embodiment of the invention, the check to determine whether it is possible to form a further simplex which contains a section of the path [x, x₀] is carried out as follows: firstly, the vertices of the facet which is intersected by the path [x, x₀] are determined. Then a further point is selected from the set P. This can be any desired point which is not associated with the vertices of the facet.

A further simplex is then formed on a trial basis from the further point and the vertices. If this further simplex which is formed on a trial basis contains a section of the path [x, x₀], this further simplex which is formed on a trial basis is used as the simplex for a further iteration of the method.

If such a section of the path [x, x₀] is not contained in the simplex formed on a trial basis, the further point which is selected from P is replaced by another point in order to form a further simplex on a trial basis, and in order to carry out again the subsequent check to determine whether a section of path [x, x₀] is in the simplex formed on a trial basis.

This method is carried out until either a further simplex has been found or all the points which are possible from the set P have been selected without a simplex which fulfils the secondary condition of containing a section of the path [x, x₀] having been formed. In this case, the method ends with the conclusion that it is not possible to form a further simplex which contains a section of the path [x, x₀], that is to say x is outside the convex envelope.

According to a further preferred embodiment of the invention, a different geometric property of the convex envelope is used. This property is as follows:

If there is a hyper-plane through the point x to be investigated so that all the pᵢεP are located on one side of the plane, the point x is outside the convex envelope formed by P (set of Hahn-Banach). If there is no such plane, the point lies in the interior.

According to a further preferred embodiment of the invention, in order to answer the question as to whether or not a point x is in the convex envelope, it is checked whether the equation system given by the analytical definition of the convex envelope can be solved. For this purpose, an iterative method is used.

According to a further preferred embodiment of the invention, a model for checking whether an input data record is in a permitted working range of the neural network is positioned before a neural network. If the respective system is a system with a plurality of neural networks and/or a system with rigorous model components, that is to say a so-called hybrid model, such a module is preferably positioned before each neural network of the system. If a plurality of neural networks is used, these modules can be logically linked to a logic “AND” in order to ensure that an input data record is in the permitted working range of all these neural networks. This is significant in particular in hybrid models.

### BRIEF DESCRIPTION OF THE DRAWINGS

In what follows, preferred embodiments of the invention are explained in more detail with reference to the drawings, in which:

FIG. 1 shows a flowchart of a first embodiment of a method for checking whether an input data record is in the convex envelope,

FIG. 2 shows a development of the method from FIG. 1 for determining a further simplex,

FIG. 3 shows a further embodiment of a method according to the invention for checking whether an input data record is in the convex envelope,

FIG. 4 shows a graphic illustration of the method in FIG. 3,

FIG. 5 shows a further embodiment of the method for checking whether an input data record is in the convex envelope, based on a check as to whether there is a solution for the equation system provided by the analytical definition of the convex envelope,

FIG. 6 shows a block diagram of an embodiment of a system according to the invention.

### DETAILED DESCRIPTION OF THE PRESENTLY PREFERRED EMBODIMENTS

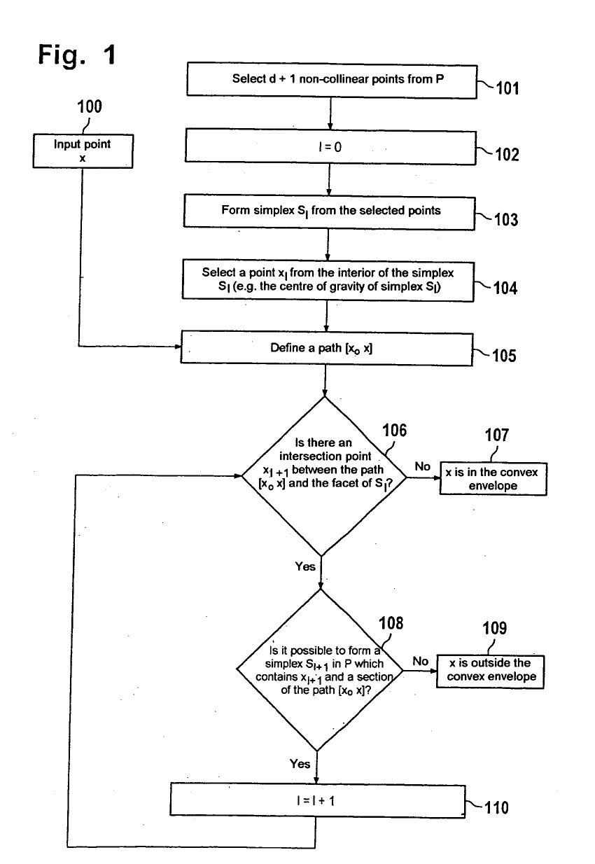

FIG. 1 illustrates a first embodiment of the method for checking whether an input data record is in the convex envelope. This method starts from a point x₀ in the interior of the convex envelope and checks whether the path [x, x₀] is in the interior of the convex envelope.

Here, x is the point which is determined by the input record and it is desired to determine whether this point also lies within the interior of the convex envelope.

For this purpose it is tested whether the path [x, x₀] intersects one of the facets of the convex envelope. If this is the case, the point x lies outside. Here, use is made of the geometric property of the convex envelope that any linear connection between any two points on the convex envelope lies completely in the convex envelope.

This method is based on the procedure described below:

A d-dimensional space R^{d} is assumed, d being the number of non-collinear training input data records of the neural network. The set P of points includes all the training input data records with which the neural network has been trained. This set P of points is therefore contained completely in the space R^{d}. In addition, a point x₀ will be assumed from the interior of the convex envelope which is formed by P, with a known representation as a convex linear combination of the points from P, i.e. there are λ₁⁽⁰⁾, . . . ,λₙ⁽⁰⁾≧0 where λ₁⁽⁰⁾+ . . . +λₙ⁽⁰⁾=1 and λ₁⁽⁰⁾p₁+ . . . +λₙ⁽⁰⁾pₙ=x₀. According to the set of Caratheodory, the coefficients λᵢ(i=1, . . . ,n) can be selected such that all are equal to 0 with the exception of d+1. In addition, it is assumed xεR^{d} is a point for which it is to be investigated whether or not it lies in the interior of conv(P).

It is assumed that [x, x₀] is the path between the points x and x₀. The known coefficients λᵢ⁽⁰⁾ (i=1, . . . ,n) are then modified in such a way that a linear combination with the new coefficients yields a point x₁ which is located on the path [x₀x]. This procedure is repeated until finally the point x is found, or one of the lateral boundaries of the convex envelope is reached.

In order to modify the coefficients λᵢ⁽⁰⁾, a suitable solution of the following, underdetermined, linear equation system is searched for:

$${\sum }_{i = 1}^{n} {ϵ}_{i} {p}_{i} = x - {x}_{0} \\ {\sum }_{i = 1}^{n} {ϵ}_{i} = 0 \qquad Equation 1$$

Then, a factor c>0 is determined such that λᵢ⁽⁰⁾+cεᵢ≧0 for i=1, . . . , n applies. It will then be assumed that λᵢ⁽¹⁾:=λᵢ⁽⁰⁾+cεᵢ. Then, x₁:=λ₁⁽ⁱ⁾p₁+ . . . +λₙ⁽ⁱ⁾pₙ is a convex linear combination for a point x₁εconv(P) which is nearer to x than x₀. If the above-described linear combination in which at maximum d+1 coefficients are unequal to 0 has been assumed for x₀, and if the largest possible c is selected, in this way the intersection point of the path [x₀,x] with a facet of the simplex which is formed by the points from P which are associated with the coefficients is obtained.

However, the equation system of the equation 1 cannot be solved in a uniquely defined way and a c>0 that fulfils the abovementioned requirements in order to determine new coefficients λᵢ⁽¹⁾ cannot be found for each solution.

Furthermore, an iterative method is specified which makes it possible to answer the question as to whether a solution of the equation system exists, and thus whether or not the point x is in the convex envelope:

Initialization step: it is assumed that d is the dimension of the space in which the convex envelope is located. In order to determine a starting value x₀, d random, linearly independent points qⱼ⁽⁰⁾εP for j=1, . . . ,d are selected. Then, a

x₀=λ₁⁽⁰⁾q₁⁽⁰⁾+ . . . +λ_{d}⁽⁰⁾q_{d}⁽⁰⁾εconv(q₁⁽⁰⁾, . . . ,q_{d}⁽⁰⁾)

will be selected as the starting value. Furthermore, we assume i=0.

Iteration step: a (d−1)-dimensional hyper-area is uniquely defined in the R^{d} through the points q₁⁽ⁱ⁾, . . . ,q_{d}⁽ⁱ⁾. This hyper-area will be expanded by adding a further point from the set P to form a d-dimensional simplex. It will now be assumed that q_{d+1}⁽ⁱ⁾εP is the point with the property that the longest possible part of the path xᵢx is in the interior of the simplex q₁⁽ⁱ⁾, . . . ,q_{d+1}⁽ⁱ⁾.

In order to discover this point, it is necessary to solve virtually the same equation system repeatedly, which can be carried out efficiently. If it is not possible to find a further vertex of the simplex, the point x is outside the convex envelope and the method is aborted. Otherwise, the equation system

$${\sum }_{j = 1}^{d + 1} {ϵ}_{j} {q}_{j}^{( i )} = x - {x}_{i}$$

$${\sum }_{j = 1}^{d + 1} {ϵ}_{i} = 0$$

has a uniquely defined solution (ε₁, . . . ,ε_{d+1}) and it is possible to select a c>0 with the properties described above. It is then assumed that:

$$\begin{matrix}{λ}_{j}^{( i + 1 )} := {λ}_{j}^{( i )} + c {ϵ}_{j} \\ {x}_{i + 1} := {\sum }_{j = 1}^{d + 1} {λ}_{j}^{( i + 1 )} {q}_{j}^{( i )}\end{matrix}$$

for j=1, . . . , d+1. It is possible to select c in such a way that either one of the λⱼ⁽ⁱ⁺¹⁾ (for j=1, . . . , d+1) is equal to 0 or c=1 applies. If the case c=1 occurs, the point x is in the interior of the convex envelope and the method can be terminated.

Otherwise, a further iteration step has to be carried out. As points q₁⁽ⁱ⁺¹⁾, . . . ,q_{d}⁽ⁱ⁺¹⁾ the d points will be selected from the set {q₁⁽ⁱ⁾, . . . ,q_{d+1}⁽ⁱ⁾} in which the respectively associated λⱼ⁽ⁱ⁺¹⁾ (j=1, . . . , d+1) is unequal to 0. Then, i is increased by 1.

If the point x is in the interior of the convex envelope of P, the algorithm supplies a convex linear combination to represent the point. If the point lies outside, d points through which a hyper-plane E is determined, which separates the point set P from the point x, are obtained. This means that all the points of the R^{d} which lie on the same side of E as the point x cannot be associated with the convex envelope. This can be utilized for a multiple evaluation in order to speed up the entire evaluation considerably.

One form of implementation of this method is illustrated in FIG. 1:

In step 100, an input data record for which a prediction is to be created is input. This input data record for the neural network determines a point x.

In step 101, a number of d+1 non-collinear points is selected from the set P.

In step 102, the index l is set to zero. In step 103, a simplex Sₗ is formed from the points selected instep 101.

In step 104, a point xₗ is selected from the interior of the simplex Sₗ. The center of gravity is calculated, for example, from the vertices of the simplex Sₗ in order to obtain the point xₗ.

In step 105, a path [xₗx] is defined between x and xₗ.

In step 106 it is checked whether an intersection point xₗ₊₁ of the path [xₗx] with a facet of the simplex Sₗ is located between x and xₗ. It is therefore checked whether, starting from xₗ on the straight line in the direction of x, firstly x or a facet of the simplex Sₗ is reached.

If there is such an intersection point xₗ₊₁ of the path [xₗx] with a facet of Sₗ, this means that the point x is not within the simplex Sₗ. If the opposite is the case, in step 107 there is an output indicating that x is in the convex envelope, as of course it has been determined that x is in the simplex Sₗ, and this is in turn completely inside the convex envelope.

If, on the other hand, the point x is outside the simplex Sₗ, in step 108 it is checked whether it is possible to find a further simplex Sₗ₊₁ in P which includes both the intersection point xₗ₊₁ and a section of the straight line g. If this is not possible, in step 109 there is an output indicating that x is outside the convex envelope.

In the opposite case, the index l is increased by one in step 110, and step 106 is carried out again with respect to the further simplex.

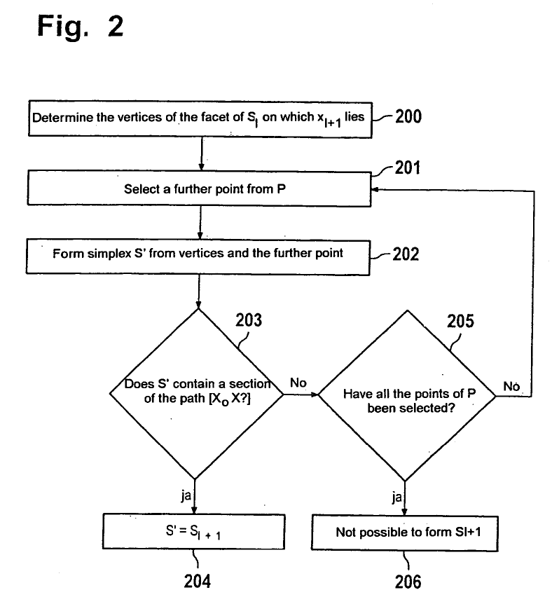

FIG. 2 shows a development of the method in FIG. 1 for carrying out the check in step 108. In order to carry out this check, the vertices of the facet of Sₗ, on which the intersection point xₗ₊₁ is located, are firstly determined in step 200.

In step 201, a further point is selected from P which is not already a vertex of the facet of Sₗ, and which is not collinear with respect to the vertices of the facet.

In step 202, a simplex S′ is formed from the vertices and the further point from P.

In step 203 it is checked whether the simplex S′ includes a section of the path [xₗx]. If this is the case, the further simplex Sₗ₊₁ which is being searched for is made equal to the simplex S′ in step 204. This then also answers the question that it is actually possible to form such a simplex Sₗ₊₁.

If the check in step 203 reveals that the simplex S′ does not contain a section of the straight line g, in step 205 it is checked whether all the possible points from P have already previously been selected in step 201. If this is not the case, in step 201 a further point from P which has not yet been previously selected is selected in order to carry out a farther iteration of the method.

If it was not possible to find a simplex Sₗ₊₁ after “trying out” all the points which are possible from P, a corresponding item of information is output in step 206. This means at the same time, that the point x is outside the convex envelope.

In this embodiment it is of particular advantage that in all cases, after a finite number of steps, the method indicates whether or not the input data record is in the convex envelope, and thus in the working range.

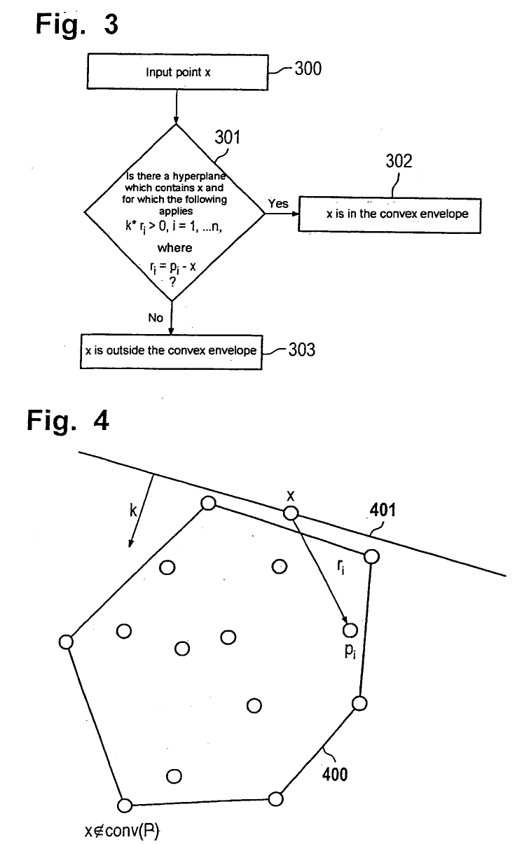

FIG. 3 shows a further embodiment of a method for checking whether an input data record is in the convex envelope. This method is not obtained directly from the definition of the convex envelope as a linear combination of the support points. Instead, a different geometric property of the convex envelope is used here, and is also illustrated graphically in FIG. 4:

If there is a hyper-plane through the point x to be investigated so that all the pᵢεP are on one side of the plane, the point x then lies outside the convex envelope formed by P. If there is no such plane, the point is in the interior.

If the plane is represented by means of the normal vector k, the condition “all points pᵢεP lie on one side of the plane” can be expressed as follows:

k·rᵢ>0, i=1. . . n

rᵢ=pᵢ−x being the position vectors of the data points in a coordinate system which has the data point to be investigated at the origin.

Without restricting the generality, inequality can be interrogated with respect to “greater” as the normal vector −k represents the same hyper-plane as k. Points on the facets of the convex envelope lead to a scalar product equal to 0 and are thus a component of the convex envelope.

An optimization method is preferably used for searching for a hyper-plane.

Here, the following target function is minimized when the normal vector k varies:

$$F = - min ( \frac{k \cdot {r}_{i}}{\vert k \vert} )$$

If the optimum of F is smaller than 0, the point to be investigated lies outside the convex envelope. For points within the convex envelope it is not possible to find a hyper-plane for which F<0 applies.

For the use as an optimization method, various methods are possible, for example the MATLAB routine fminsearch as well as gradient methods, Levenberg-Marquard algorithm or an evolution strategy which can also be used in combination with local methods.

An advantage which is significant for the running time behaviour of the algorithm is that, if a corresponding hyper-plane has been found for a data point, said hyper-plane also constitutes a solution for all the points on the side of the plane lying opposite the convex envelope. If the investigation for membership of the convex envelope is to be carried out simultaneously for a plurality of data points, the method can thus be considerably speeded up.

FIG. 3 illustrates this method by reference to a flowchart. In step 300, the input data record, that is to say the point x, is input.

In step 301, it is checked by means of one or more of the aforesaid methods, whether there is a hyper-plane which contains x and for which k·rᵢ>0, i=1, . . . ,n applies, where k is the normal vector of the searched-for hyper-plane, and rᵢ is the difference vector between a point pᵢ and x provided by a training input data record.

If there is such a hyper-plane, it follows in step 302 that x is in the convex envelope. In the opposite case, in step 303 information is output according to which x is outside the convex envelope.

The check in step 301 to determine whether there is a suitable hyper-plane is illustrated in FIG. 4. The points pᵢ located in the grey-hatched area of FIG. 4 form a convex envelope 400. The point x is located outside the convex envelope 400. Between the point x and the points pᵢ there are the difference vectors rᵢ=pᵢ−x.

A hyper-plane 401, which is described by the normal vector k, runs through x. As all the points pᵢ of the convex envelope 400 are located on the same side of the hyper-plane 400, it follows from this that x is actually outside the convex envelope 400.

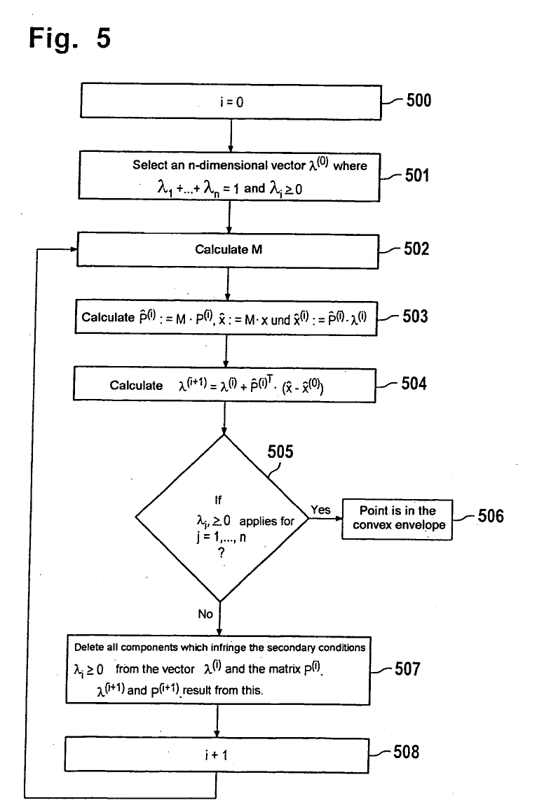

FIG. 5 illustrates a further method for checking whether an input data record x is in the convex envelope.

In this method it is checked whether there is a solution for the equation system which is obtained from the analytical definition of the convex envelope.

λ₁p₁+ . . . +λₙpₙ=\tilde{x}

λ₁+ . . . +λₙ=1 Equation 2

Here, a solution is searched for so that the secondary conditions λᵢ>0 are fulfilled. In the following method, successive attempts are made to achieve this.

As in the method in FIGS. 1 and 2, in this case also an initial solution for λ⁽⁰⁾:=(λ₁⁽⁰⁾, . . . , λₙ⁽⁰⁾) is assumed for which in general the inequality secondary conditions are not fulfilled.

Equation 2 is written below in matrix form. Then,

P⁽⁰⁾λ=x Equation 3

is obtained where a line of ones has been added to the vector x and to the dot matrix P⁽⁰⁾ respectively.

Initialization Step

We assume i=0 and select a random n-dimensional vector

λ⁽⁰⁾=(λ₁, . . . ,λₙ) where λ₁+ . . . +λₙ=1

and λᵢ≧0.

Iteration Step

Firstly, we transform the equation 3 by multiplying it on both sides by a matrix M. The matrix M is to be selected here in such a way that the lines of the matrix \hat{P}⁽ⁱ⁾:=M·P⁽ⁱ⁾ are ortho-normed (if such a matrix M does not exist, dependent lines in the matrix P⁽ⁱ⁾ can be omitted). In addition, it is assumed that \hat{x}:=M·x . It is not attempted now to solve the equation system \hat{P}⁽ⁱ⁾λ=\hat{x} directly but instead we start from the known coefficient vector λ⁽ⁱ⁾ and assume \hat{x}⁽ⁱ⁾:=\hat{P}⁽ⁱ⁾λ⁽ⁱ⁾. We then search for a solution of the equivalent equation system

\hat{P}⁽ⁱ⁾·(λ−λ⁽ⁱ⁾)=\hat{x}−\hat{x}⁽ⁱ⁾.

As in most cases this equation system is underdetermined, we search for the solution λ so that ∥λ−λ⁽ⁱ⁾∥ is minimal (where ∥·∥ designates the Euclidean norm). Here, we can make use of the fact that the matrix \hat{P}⁽ⁱ⁾ is ortho-normed. The following applies

λ=λ⁽ⁱ⁾+\hat{P}^{(i)T}·(\hat{x}−\hat{x}⁽ⁱ⁾),

\hat{P}^{(i)T} being the transponent of the matrix \hat{P}⁽ⁱ⁾. If all the components of the coefficient vector λ which is found in this way fulfil the secondary conditions λᵢ≧0, a convex linear combination for the point x has been found, and the point x is therefore in the interior of the convex envelope. Otherwise, we set all the coefficients which infringe the secondary condition for the rest of the method to zero, and attempt to correct the components which do not infringe the secondary condition in such a way that this step is compensated for. In practical terms, this is brought about by the fact that all the components which infringe the secondary condition, from the vectorλ, and all the associated columns are eliminated from the matrix \hat{P}.

The vector which is obtained in this way with a relatively small dimension and the matrix which is obtained in this way with fewer columns are designated by λ⁽ⁱ⁺¹⁾ and P⁽ⁱ⁺¹⁾.

For the correction, the (smaller) equation system

P⁽ⁱ⁺¹⁾λ=\hat{x}

must be solved. To do this, a further iteration step is then carried out, i being increased by one, this time with λ⁽ⁱ⁺¹⁾ as the starting value. If the equation system cannot be solved, there is no convex linear combination for the point x and the point is located outside the convex envelope.

As at least one column is always eliminated at each iteration step, the method comes to a result after a maximum of n steps.

One embodiment of this method is illustrated in FIG. 5.

In step 500, the index i is set to be equal to zero. In step 501, a starting value for the n-dimensional vector λ⁽⁰⁾ which fulfils the secondary conditions is selected. For this purpose, it is possible to select, for example, λᵢ=1/n.

In step 502, the matrix M is calculated. On the basis of this, in step 503 the matrix \hat{P}⁽ⁱ⁾ and the vectors \hat{x} and \hat{x}⁽ⁱ⁾ are calculated.

On the basis of this, in step 504, λ=λ⁽ⁱ⁾+\hat{P}⁽ⁱ⁾^{^{T}}·(\hat{x}−\hat{x}⁽ⁱ⁾) is calculated.

In step 505, it is checked whether all λᵢ(j=1, . . . ,n) of the vector calculated in step 504 are λ>0. If this is the case, in step 506, it follows that the point provided by the input data record is within the convex envelope.

If the opposite is the case, in step 507 all the components of the vector λ and the corresponding columns matrix P⁽ⁱ⁾ which infringe the secondary condition are deleted. This results in the smaller equation system P⁽ⁱ⁺¹⁾λ=\hat{x}.

In step 508, the index i is incremented in order to carry out a further iteration of the method.

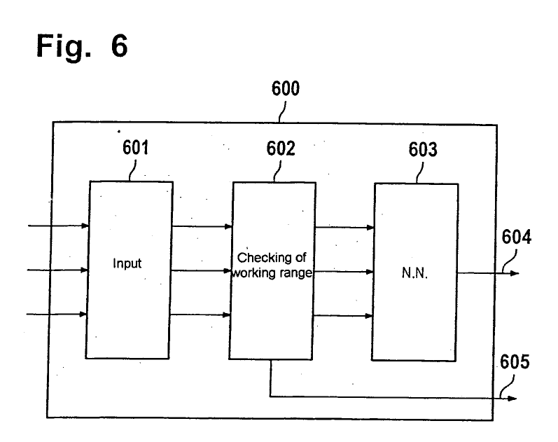

FIG. 6 shows a block diagram of an embodiment of a system 600 according to the invention. The system 600 has an input module 601 for inputting an input data record which is composed of a=3 parameters in the example considered here.

The input module 601 is logically linked to a module 602 which is used for checking whether an input data record lies within the convex envelope of the neural network 603. This checking is carried out, for example, according to a method which is described with respect to FIGS. 1 to 5, or according to another method.

The module 602 is logically linked to the neural network 603. If the module 602 determines that an input data record is in the permitted working range of the neural network which is provided by the convex envelope, this input data record is input into the neural network 603, which then outputs at least one predicted value at its output 604. On the other hand, if the module 602 determines that the input data record is not in the permitted working range, a corresponding signal is emitted at the output 605, after which no reliable prediction is possible for the current input data record.

In addition to the neural network 603, the system 600 can also contain further neural networks (hybrid model), each of which having in turn arranged upstream of it a module which corresponds to the module 602. The results of the individual modules 602 must then be logically linked to a logic “AND”. This ensures that all the neural networks of the hybrid model 600 are operated in a permitted working range for a specific input data record of the input module 601. In addition, the system 600 can also contain rigorous model components.

1. A method for checking whether an input data record is in a working range of a neural network, comprising the following steps:
(a) storing training input data records for the neural network, forming a convex envelope being formed by means of the training input data records,
(b) checking whether the input data record is in the convex envelope.

2. The method according to claim 1, further comprising the steps:
(c) selecting a number (d+1) of non-collinear points from the set of training input records,
(d) forming a first simplex (S₁) from the selected points,
(e) selecting a point (xₗ) from the interior of the first simplex (Sₗ),
(f) definition of a path between the input data record and the selected point,
(g) checking whether there is an intersection point (xₗ₊₁) between the path and a facet of the first simplex, and
(h) checking whether a second simplex (Sₗ₊₁) which contains the intersection point and a section of the path can be formed from the number of points from the training input data records.

3. The method according to claim 2, further comprising the steps for checking whether a second simplex may be formed:
(i) determining vertices of a facet of the first simplex on which the intersection point is located,
(j) selecting a further, non-collinear point from the training input data records,
(k) forming a simplex (S′) from the vertices and the further point,
(l) checking whether the simplex contains a section of straight line, and outputting the simplex as a second simplex, if this is the case,
(m) exchanging the further point for another, non-collinear point from the set of training input data records and renewed checking.

4. The method according to claim 1, it is checked whether there is a hyper-plane which contains the input data record so that all the training input data records are located on one side of the hyper-plane.

5. The method according to claim 4, wherein a minimum of F being searched for in order to check whether a hyper-plane exists, where
$$F = - min ( \frac{k \cdot {r}_{i}}{\vert k \vert} )$$
and where the hyper-plane is represented by the normal vector k and rᵢ=pᵢ−x, where x is the point defined by the input data record.

6. The method according to claim 1, further comprising the additional steps of:
selecting an initial vector λ⁽⁰⁾=(λ₁, . . . ,λₙ) with λ₁+ . . . +λₙ=1 and λⱼ≧0(j=1, . . . ,n), where preferably
$${λ}_{j} = \frac{1}{n}$$
is selected,
selecting a matrix M in such a way that the lines matrix \hat{P}⁽ⁱ⁾:=M·P⁽ⁱ⁾ are orthonormed,
calculating λ=λ⁽ⁱ⁾+\hat{P}^{(i)T}·(\hat{x}−\hat{x}⁽ⁱ⁾), where \hat{x}⁽ⁱ⁾:=\hat{P}⁽ⁱ⁾λ⁽ⁱ⁾,
checking whether all λⱼ≧0 (for j=1, . . . ,n),
deleting all components from the matrix P⁽ⁱ⁾ and from the vector λ⁽ⁱ⁾, which infringe the secondary condition λⱼ≧0 (for j=1, . . . ,n),
renewed calculating of λ.

7. A system for determining at least one predicted value, comprising
at least one neural network which has been trained using a set of training input data records,
means for checking whether one of the input data record for the neural network is in the convex envelope which is formed by the training input data records.

8. The system according to claim 7, further comprising a hybrid model which contains at least a first neural network and a second neural network, the first neural network having been trained using a set of first training input data records, and the second neural network having been trained using a set of second training input data records, the checking means being embodied in such a way that for a first input data record for the first neural network it is checked whether the first input data record is in the convex envelope which is formed by the first training input data records, and that it is checked for a second input data record for the second neural network whether the second input data record is in the convex envelope which is formed by the second training input data records, the assignment of the first input data record to the first neural network and the assignment of the second input data record to the second neural network being carried out in automated fashion from a composite data record.

9. The system according to claim 8, wherein the checking means being embodied in such a way that the checking is carried out in accordance with a method according to claim 1.

10. A computer digital storage medium program product for carrying out a method according to claim 1.
